(19) United States
(12) Patent Application Publication
(10) Pub. No.: US 2026/0079382 A1
(43) Pub. Date: Mar. 19, 2026

(54) MOTOR MOUNT FOR A CINEMATOGRAPHY LENS

(71) Applicant: Light Widow LLC, Glenwood Springs, CO (US)

(72) Inventors: Van WAMPLER, Glenwood Springs, CO (US); Colton CRANDELL, Centennial, CO (US)

(73) Assignee: Light Widow LLC, Glenwood Springs, CO (US)

(21) Appl. No.: 19/329,740

(22) Filed: Sep. 16, 2025

Related U.S. Application Data
(60) Provisional application No. 63/695,490, filed on Sep. 17, 2024.
(60) Provisional application No. 63/715,046, filed on Nov. 1, 2024.

(51) Int. Cl. G03B 5/00; G03B 13/34; G03B 19/18; H02K 5/26; H02K 7/116

(52) U.S. Cl. CPC G03B 5/00; G03B 13/34; H02K 5/26; H02K 7/116; G03B 19/18; G03B 2205/0046; H02K 2213/09

(57) ABSTRACT

A motor mount for a cinematography lens of a camera is provided. A main body has a first end and an opposite second end, the first end configured to fixedly couple to a camera rod of the camera and the second end is configured to support a moveable arm. The arm is configured to support a motor for selective engagement with the cinematography lens. An actuator is supported on the main body proximate the second end. The actuator is coupled to the arm such that the motor is moveable via the actuator between at least a first position whereby the motor is disengaged with the cinematography lens and a second position whereby the motor is engaged with the cinematography lens and without movement of the main body on the camera rod.

### CROSS-REFERENCE TO RELATED APPLICATIONS

This application claims priority to and the benefit of U.S. Provisional Application No. 63/715,046, filed Nov. 1, 2024, and U.S. Provisional Application No. 63/695,490, filed Sep. 17, 2024. The disclosures of each of the foregoing applications are incorporated by reference herein in their entireties.

### BACKGROUND

In cinematography, it is common practice to use camera lenses that manually focus and zoom, with a manually adjustable iris. The focus, zoom, and iris controls are commonly changed by turning rings that extend around the circumference of the lens, each ring placed in a different position on the lens. It is also common for each focus, zoom, or iris ring to have gear teeth placed around the circumference of the ring. In the earlier days of film, this was so that the lens rings could be moved by a control knob with an interlocking gear. The control knob, known as a “follow focus”would usually be attached to two rails that extended below the camera lens.

In more recent years, it has become commonplace to control the focus, zoom, and iris via a wireless connection using motors with gears that mesh with each of the control rings. For instance, a wireless motor for the focus, one for the zoom, and one for the iris. These motors are often called “FIZ” or “FI+Z” motors (an acronym for Focus Iris+Zoom). With the evolution of the FIZ motors, the camera rod system has also evolved so that placements and diameter of the camera rods vary, but the basic procedure of attaching a FIZ motor is pretty standard. The motor attaches to either a 15 millimeter (mm) or 19 mm camera support rod or rail that extends either below or above the lens. Sometimes a rod clamp is located directly on the motor, or sometimes the motor attaches to an elongated arm that then attaches to the rod. In operation, placement of the motors relative to the lens includes loosening the rod clamp and moving the motor around the axis of the rod so that a motor gear lines up with the lens gear. In examples, a forward most gear of the camera controls the focus, the next gear back controls zoom, and the gear furthest towards the camera body controls iris. The rod clamp is typically removable from the motor using the same loosening knob that controls the clamping pressure to attach to the rod. The rod clamp may use a dovetail mount to attach to the motor, allowing the rod clamp to be relocated to a number of positions along the inside surface of motor and to accommodate for different lens sizes and configurations. The motors are connected via cables to a wireless control unit, though some motors have the control unit built in.

It is common during a film production to use sets of lenses where each lens in the set has a consistent diameter and a consistent distance between iris, focus, or zoom rings. For example, a distance between the focus ring and the iris ring is the same for every focal length, as is the diameter of each lens. Some lens sets are made up of prime (fixed focal length) lenses and therefore may not have a zoom ring. If the lens is to be swapped for another lens on the camera, each of the motors has to be individually loosened using the rod clamp in order to be repositioned and allow clearance for the lens to be removed and another lens inserted. The lens that is swapped in has identical dimensions (e.g., the focus, zoom, and iris rings all being the same diameter and same distance from the camera body) to the lens being replaced. This means that once the lens is swapped, the motors should not have to be repositioned to fit the new lens, aside from swinging the gears away to allow clearance for the lens change.

Lenses also commonly have limited rotation to a focus, zoom or iris control. A focus ring, for instance, can only rotate so many degrees in either direction before it hits a stop—one stop at the closest focus distance, and one stop at the furthest focus distance. To calibrate a focus motor, the system must go through an initializing process where when the motor is first connected to a lens, the motor will turn the ring to each end of its rotation in order for the system to record the full travel distance of the ring. Some cinema lenses have fairly stiff focus, zoom, or iris rings. This means that sometimes there is a surprisingly high amount of torque required from a focus motor to successfully control the lens. This means that, during calibration, when the end stop of ring rotation is reached, sometimes the motor will hit the stop with so much power that the gears are forced apart. This is a result of not only high torque, but either flex in the system (often in the rod that is attached to the camera) which allows the motor to flex away from the lens, or inadequate clamping force at one of the motor attachment points-usually where the clamp tightens around the camera rod. For instance, if the clamp lever is not tightened adequately, the motor may rotate away from the lens. As already mentioned, motor gears usually disengage from the lens at the hard end stops of the lens ring rotation, but sometimes the motors can also disengage with quick movements, direction changes, or from slowly pushing away from the lens over time. This is almost always due to lack of proper clamping force where the motor or elongated arm attaches to the camera rod, or sometimes where the rod attaches to the camera rig. Over the course of a shooting day which can involve numerous lens changes, it can become tedious to constantly untighten the clamping mechanism, swing the motor away and back into position, and retighten the rod clamp. With the procedure being necessary a number of times, it is not uncommon for a camera user to tighten the clamp too lightly on occasion, leading to the motor slipping off the lens. This can be undesirable if it happens during a shot, as focus control is essential to a successful take. It can also eat up valuable time on set as the production holds to wait for the motor to recalibrate.

### SUMMARY

A cinematography lens motor mount is described herein and provides a fast and secure way of finely adjusting positioning (e.g., engaging and disengaging) a geared lens Focus Iris+Zoom (“FIZ” or FI+Z”) motor to and from a geared focus, iris, or zoom section of the cinematography lens.

In an aspect, the technology relates to a motor mount for a cinematography lens including: a first body member having a first end configured to couple to an external rod of a camera and an opposite second end; a second body member having a first end and a second end defining a longitudinal axis, wherein the first end of the second body member is rotatably coupled to the second end of the first body member about a rotation axis, the second body member selectively securable in a plurality of different rotational positions relative to the first body member around the rotational axis; an adjustable arm having a first end pivotably coupled to the second body member between the first end and the second end of the second body member and a second end configured to couple to a motor; and an adjustment mechanism coupled between the adjustable arm and the second body member, wherein the adjustment mechanism includes a thumbturn configured to pivotably position the adjustable arm relative to the second body member at a pivot angle relative to the longitudinal axis for engaging the motor with the lens, and wherein the adjustment mechanism also includes a biasing member such that when the thumbturn releases the pivot position of the adjustable arm to disengage the motor from the lens, the adjustable arm automatically pivots towards the second body member and the longitudinal axis without movement of the first and second body members.

In an example, the thumbturn is a knob threadingly engaged with the second body member proximate the second end of the second body member. In another example, the knob has an exterior end and an interior end, the interior end engaged with a ball bearing housed within the adjustable arm. In still another example, a pivot axis of the adjustable arm is parallel to the rotational axis. In yet another example, the biasing member is housed within the adjustable arm, and force generated by the biasing member is adjustable via a screw extending between the second body member and the adjustable arm. In an example, the force biases the adjustable arm in a direction towards the longitudinal axis of the second body member.

In another example, the motor is integrated within the adjustable arm. In still another example, the motor mount includes an anti-twist bracket, the first end of the first body member coupled to a portion of the anti-twist bracket. In yet another example, the motor mount includes an offset arm, one end of the offset arm coupled to the second end of the adjustable arm and an opposite end configured to couple to the motor.

In another aspect, the technology relates to a motor mount for a cinematography lens of a camera including: a main body having a first end and an opposite second end, the first end configured to fixedly couple to a camera rod of the camera; an arm movably supported on the main body, the arm including a clamp configured to couple to a motor; and an actuator supported on the main body proximate the second end, the actuator coupled to the arm such that the clamp of the arm is moveable via the actuator between at least a first position whereby the motor is disengaged with the cinematography lens and a second position whereby the motor is engaged with the cinematography lens without movement of the main body on the camera rod.

In an example, the arm is pivotably coupled to the main body and the clamp of the arm is pivotable between the first and second positions. In another example, the actuator includes a biasing member that biases the arm and the clamp towards the first position. In still another example, the second end of the main body defines elongated channel and the arm is at least partially disposed within the elongated channel, and an end wall of the elongated channel defines a rotational stop for the arm. In yet another example, the arm is pivotable relative to the main body around a pivot axis, and the actuator is a knob rotatable around a rotation axis, the pivot axis orthogonal relative to the rotation axis. In an example, the main body includes two or more members with an adjustable angle joint therebetween.

In another example, a first member of the two or more members has a second clamp that couples to the camera rod of the camera and a second member of the two or more members supports the arm such that the arm is spaced apart from the first member. In still another example, the clamp of the arm is disposed outside of the second member. In yet another example, the first end of the main body includes a clamp having a thrust bearing for attaching to the camera rod. In an example, the arm further includes the motor housed at least partially within the arm. In another example, the motor mount further includes an anti-twist bracket having a first end coupled to the first end of the main body and an opposite second end configured to couple to a second camera rod of the camera.

In another aspect, the technology relates to a motor mount for a cinematography lens of a camera including: a main body having a first end and an opposite second end, the first end configured to fixedly couple to a camera rod of the camera; an articulating arm having a first end and an opposite second end, the first end pivotably coupled to the main body at a pivot axis, the pivot axis disposed between the first and second ends of the main body, the second end configured to support a motor; and an actuator supported on the main body proximate the second end of the main body, the actuator coupled to the articulating arm such that the actuator drives pivoting movement of the articulating arm around the pivot axis relative to the main body.

In an example, the main body includes a first member at the first end of the main body and a second member at the second end of the main body, the first member including a clamp for securing the main body to the camera rod, and the first member and the second member are coupled at a joint such that an angle between the first member and the second member is adjustable. In another example, the joint between the first member and the second member is a rosette joint. In still another example, the actuator includes a threaded knob having a distal end engaged with the articulating arm and a biasing member configured to urge the articulating arm towards the main body. In yet another example, the second end of the articulating arm includes a clamp configured to couple to the motor. In an example, the articulating arm further includes the motor housed at least partially within the second end of the articulating arm.

In another example, the motor mount further comprises an offset arm having a first end attached to the second end of the articulating arm and an opposite second end configured to support the motor. In still another example, the motor mount further comprises an anti-twist bracket having a first end coupled to the first end of the main body and an opposite second end configured to couple to a second camera rod of the camera.

In another aspect, the technology relates to a motor mount for a cinematography lens of a camera including: a main body having a first end and an opposite second, the first end configured to fixedly couple to a camera rod of the camera; an articulating arm having a first end and an opposite second end, the first end pivotably coupled to the main body at a pivot axis, the pivot axis disposed between the first and second ends of the main body, the second end configured to support a motor; a knob rotatably supported on the main body proximate the second end of the main body, the knob rotatable around a rotation axis so as to push the articulating arm in a first pivoting direction around the pivot axis; and a biasing member supported at least partially within the articulating arm and biasing the articulating arm in an opposite second pivoting direction around the pivot axis.

In an example, the main body includes a first member having a clamp that couples to the camera rod of the camera and a second member supporting the articulating arm such that the articulating arm is spaced apart from the first member. In another example, the first member and the second member are coupled together at an adjustable angle joint. In still another example, the second end of the articulating arm includes a clamp configured to couple to the motor, and the clamp is disposed outside of the second end of the main body. In yet another example, the articulating arm further includes the motor housed at least partially within the second end of the articulating arm.

In another aspect, the technology relates to an anti-twist bracket for a camera including: a body having a first end and an opposite second end defining a longitudinal axis; a collar defining a first hole disposed at the first end of the body; a tube defining a second hole disposed at the second end of the body, the tube and the collar extending from the same side of the body, wherein the tube is defined by a plurality of circumferentially spaced arms defining an outer surface for receiving a motor mount, wherein the second end of the body defines a gap in communication with the second hole and configured to enable compression of the tube, and wherein at least one slit is defined within the body between two of the plurality of circumferentially spaced arms and in communication with the second hole.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of a camera having a cinematography lens and a motor, the motor supported by an exemplary motor mount.

FIG. 2 is a perspective view of the motor mount shown in FIG. 1.

FIG. 3 is a cross-sectional view of the motor mount shown in FIG. 1 in a first pivoted position.

FIG. 4 is a cross-sectional view of the motor mount shown in FIG. 1 in a second pivoted position.

FIGS. 5 and 6 are exploded, perspective views of a main body and an articulation arm of the motor mount shown in FIG. 1.

FIG. 7 is another perspective view of the motor mount shown in FIG. 1.

FIG. 8 is another perspective view of the camera and the motor mount shown in FIG. 1, the motor mount also having an anti-twist bracket.

FIG. 9 is a perspective view of the anti-twist bracket shown in FIG. 8.

FIG. 10 is a front view of the anti-twist bracket shown in FIG. 8.

FIG. 11 is a rear view of the anti-twist bracket shown in FIG. 8.

FIG. 12 is a top view of the anti-twist bracket shown in FIG. 8.

FIG. 13 is a bottom view of the anti-twist bracket shown in FIG. 8.

FIG. 14 is a left-side view of the anti-twist bracket shown in FIG. 8.

FIG. 15 is a right-side view of the anti-twist bracket shown in FIG. 8.

FIG. 16 is a perspective view of an offset arm for use with the motor mount shown in FIG. 1.

FIG. 17 is a side view of the offset arm shown in FIG. 16.

FIG. 18 is a side view of another motor mount according to the principles described herein.

FIG. 19 is a side view of another motor mount according to the principles described herein.

FIG. 20 is a side view of another motor mount according to the principles described herein.

FIG. 21 is a side view of another motor mount according to the principles described herein.

FIG. 22 is a perspective view of a rotatable camera rod assembly according to the principles described herein.

FIGS. 23 and 24 are cross-sectional views of the rotatable camera rod assembly shown in FIG. 22.

### DETAILED DESCRIPTION

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

References in the specification to “one embodiment,” “an embodiment,” “an illustrative embodiment,” “an example,” “an aspect,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other examples whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). Moreover, one having skill in the art will understand the degree to which terms such as “about,” “approximately,” or “substantially” convey in light of the measurement techniques utilized herein. To the extent such terms may not be clearly defined or understood by one having skill in the art, the term “about”shall mean plus or minus ten percent.

Throughout this description, references to orientation (e.g., front(ward), rear(ward), top, bottom, back, right, left, upper, lower, etc.) of the components of the motor mount relate to their position when installed on a camera and are used for ease of description and illustration only. No restriction is intended by use of the terms regardless of how the components of the motor mount are situated on its own. As used herein, the terms “axial” and “longitudinal” refer to directions and orientations, which extend substantially parallel to a centerline of the component or system. Moreover, the terms “radial” and “radially” refer to directions and orientations, which extend substantially perpendicular to the centerline of the component or system. In addition, as used herein, the term “circumferential” and “circumferentially” refer to directions and orientations, which extend arcuately about the centerline of the component or system.

Reference will now be made in detail to exemplary aspects of the present disclosure that are illustrated in the accompanying drawings. Wherever possible, the same reference numbers will be used throughout the drawings to refer to the same or like parts.

The motor mount assembly described herein is configured to reduce or eliminate unwanted or undesirable motor positioning by facilitating engagement and disengagement of a FIZ motor or multiple FIZ motors during a lens change. Rather than having to tighten and loosen a lever where the motor attaches to the camera rod or at any other place in the motor mount assembly, the motor mount allows the position of the motor to be finely adjustable, and engaged and disengaged from the lens by means of a dynamically articulating mounting arm with an easily adjustable actuator integrated within the motor mount. As such, a main body of the motor mount need not be moved relative to the lens when adjusting the motor placement. Additionally, the motor mount allows the motor to be over engaged with the lens as required or desired.

The dynamic arm of the motor mount is attached to the main body. The arm supports the FIZ motor, and the main body securely attaches to the camera rod. In some aspects, the arm is pivotable. In other aspects, the arm is slidable. The arm is coupled to an actuator mounted on the main body that is configured to selectively move the arm towards and away from the lens for motor engagement and disengagement therewith. The actuator is also configured to hold the arm in any intermediate position as well. This configuration allows for a wide variety of FIZ motors to be attached to a camera rod via the motor mount described herein. In some examples, the FIZ motor may be integrated within the arm as required or desired. With the movement of the arm, the motor can subsequently be moved in a direction towards or away from the camera lens along with the movement of the arm and without movement of the main body. Accordingly, the entire motor mount does not need to be repositioned during lens changes, thereby increasing performance and efficiencies.

Additionally, because a high torque motor can put a substantial amount of force not only on the lens but in the opposite direction from the lens, the arm of the motor mount is not only easily adjustable, but also is configured to remain in the engaged position via the main body and actuator, and unaffected by outside forces generated by the FIZ motor. The ability to move the arm easily by use of the actuator while maintaining rigidity via the main body against any force in a direction that is opposite of the adjustment direction and created by the attached FIZ motor not only allows for easy engagement and disengagement of a FIZ motor via the arm of the motor mount, but allows, without the constant and difficult tightening of numerous levers, the main body of the motor mount to be secured to the point where there is no way that any part will give way to the torque of the FIZ motor. This configuration allows for quicker and easier lens changes and better gear engagement that can be fine-tuned. For example, the FIZ motor is more easily positioned for meshing with the lens gear. In aspects, the FIZ motor may be positioned to at least partially be over meshed with the lens gear and for accommodating the toque generated by the motor. It is also possible to attach a number of FIZ motors to a single rod attached to the arm, allowing a user to engage and disengage multiple FIZ motors by use of a single actuator.

In other examples, the arm can be mounted in any way on the main body so that it lines up for its intended use engaging and disengaging the FIZ motor. In aspects, the camera rods often are located above the lens. In some examples, the arm could be controlled by something other than an actuator knob, and the actuator could be placed in a number of other locations on the main body. In other aspects, the arm is prevented from being forced backwards by the motor via any other additional structure or method. In still other aspects, the rod clamp attachments may be any other coupling system as required or desired. In other examples, the motor mount may include any number of sections or joints added to the main body. In another example, two motor mounts could be made to fit together where a single actuator controls them both. In still another example, the rod clamps can use adapters to go from 19 mm down to 15 mm diameters.

The motor mount also enables the user to apply pre-load engagement to the entire system. Some known camera rods often can flex between the point where the motor is mounted and where the rod attaches to the camera because the rods are cantilevered from the camera. This means that with standard mounting options, if there is enough torque on an engaged motor, the motor can force itself off of the lens simply by causing the camera rod to flex away from the lens. Similar flex may be present in every aspect of the system, including the motor clamp. The motor mount described herein facilitates a counteraction to such flex. Due to the force applied by the actuator, the user can easily and intentionally turn the actuator to “over-tighten” the FIZ motor placement and engage with the lens not only to the point where the gears make contact, but past the point where the gears contact to the point where there is spring tension or preload present throughout the system and applied by the motor mount. Once the motor is engaged in this manner, the FIZ motor has a positive force created by the spring tension in the motor mount, rod, etc. towards the lens. This means that even if the torque of the FIZ motor forces the motor away from the lens, that force must first cancel out the preload force before the gears can skip.

By adding this extra tension to the gear engagement, the motor mount can reduce or prevent the motor gear from being disengaged from the lens gear.

For example, if a user were to rotate an actuator knob clockwise, or in a way that moves the motor towards the lens to the point where the gears are engaged, the user could then continue to turn the knob in the same clockwise direction which would add preload to the system, forcing the motor toward the lens and making disengagement less likely.

In other instances, the FIZ motor could be integrated into the motor mount. For instance, the FIZ motor and gear could be directly and permanently attached to the dynamic arm. This could be a useful integration as it would eliminate the need for a separate mounting arm and clamp, as well as allow for the FIZ motor and gear to be integrated directly in line with the mounting points, rather than an offset attachment. Such integration of the motor mount directly into the motor and gear would also reduce the footprint of the motor mount on the camera rod, making it easier to mount motors close together or next to each other. Another benefit would be that the forces generated by the gear and motor would be directly in line with the arm. In examples, the FIZ motor may be supported in a housing that is disposed on the free end of the arm. Direct integration could be especially useful for smaller wireless lens control motors intended for use with lightweight cameras and compact setups.

In some examples, a separate accessory may be provided for the motor mount. In one example, a bracket that spans between two rods can also be used in conjunction with the motor mount to address twisting of the camera rod. In another example, when the motor mount is mounted on the camera rod, the FIZ motor may be disposed fairly far away from the lens.

Depending on the motor type, the distance from the motor gear to the engagement point with the lens gear can be unusable. For example, the FIZ motor gear may be disposed fairly far away from the location that the FIZ motor is clamped to the motor mount, and depending on the motor type, the distance from the motor gear to the motor mount can be undesirable such as positioning relative to the lens gear and/or compactness of the FIZ motor on the camera rig relative to other components. To solve this problem, an offset arm can be added between the motor mount and the FIZ motor so as to move the position of the motor gear relative to the motor mount for a more compact setup and for easier engagement with the lens.

In still other examples, an assembly is provided for mounting the camera rod to the camera. The assembly facilitates pivoting the camera rod around its longitudinal axis.

Accordingly, when a FIZ motor is secured to the camera rod, the pivoting movement of the camera rod facilitates positioning the FIZ motor towards and away from the camera lens as described herein.

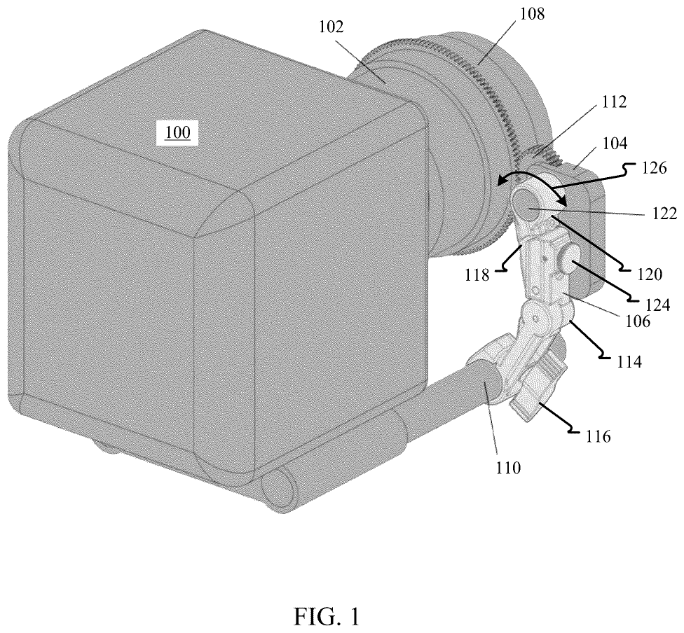

FIG. 1 is a perspective view of a camera 100 having a cinematography lens 102 and a motor 104, the motor 104 is supported by an exemplary motor mount 106. The lens 102 includes a lens gear 108 that is configured to rotate relative to the lens 102 and provide adjustment to the lens 102. The camera 100 is supported on one or more camera rods 110 that extend parallel to the lens 102, and in the example, disposed at least partially below the lens 102. In other examples, the camera rods 110 may be positioned above or to the side of the lens 102 as required or desired. The motor 104 includes a motor gear 112 that is engaged with the lens gear 108 and operable to control rotational position of the lens gear 108. In the example, the motor 104 is supported on the camera rod 110 by the motor mount 106. The motor mount 106 is configured to position the motor gear 112 of the motor 104 at the lens gear 108 for engagement and operation thereof. Additionally, the motor mount 106 is configured to quickly and easily disengage the motor gear 112 from the lens gear 108 without the entire motor mount 106 being repositioned on the camera rod 110 so as to facilitate a quick and easily lens change and operational control of the lens gear 108.

The motor mount 106 includes a main body 114 having a first clamp 116 that is configured to mount around and secure to the camera rod 110. An articulating arm 118 is pivotably coupled to the main body 114 and includes a second clamp 120. The second clamp 120 is configured to secure to a motor rod 122 that extends from the motor 104 and to support the motor 104. An actuator adjustment mechanism 124 is coupled between the main body 114 and the articulating arm 118 for driving pivoting movement 126 of the articulating arm 118 relative to the main body 114. Accordingly, the actuator adjustment mechanism 124 is configured to enable the motor 104 to pivot towards and engage with the lens 102 and pivot away from and disengage with the lens 102 for facilitating lens changes and operation of the lens gear 108. The main body 114 does not need to be moved relative to the camera rod 110 during this adjustment of the position of the motor 104 via the articulating arm 118.

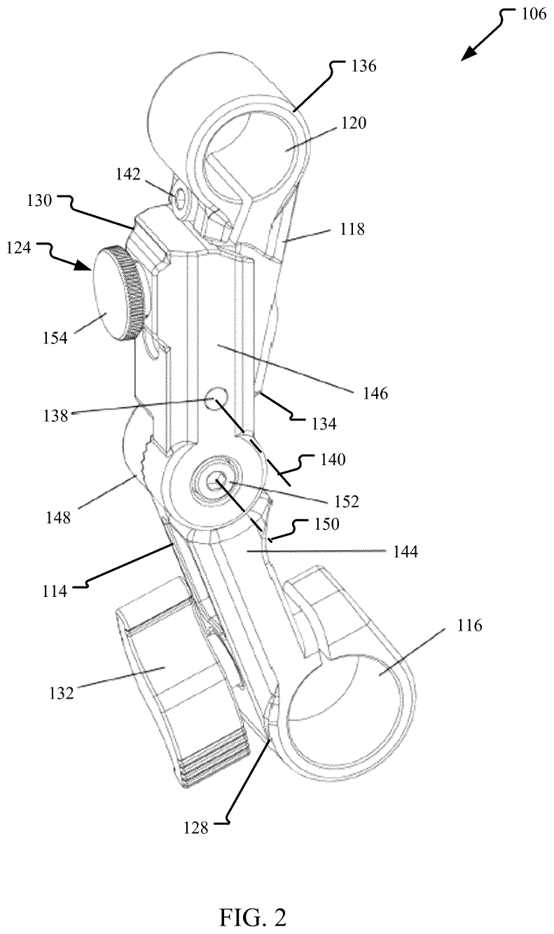

FIG. 2 is a perspective view of the motor mount 106. In the example, the main body 114 has a first end 128 and an opposite second end 130. The first end 128 includes the first clamp 116 and a tightening lever 132 for fixedly attaching the motor mount 106 to the camera rod 110 (shown in FIG. 1). The articulating arm 118 is disposed proximate the second end 130 of the main body 114. The articulating arm 118 also includes a first end 134 and an opposite second end 136. The first end 134 is pivotably coupled to the main body 114 at a pivot point 138 defining a pivot axis 140. In the example, the pivot point 138 is disposed between the first and second ends 128, 130 of the main body 114. The second end 136 includes the second clamp 120 and a fastener 142 (e.g., a bolt or lever) for fixedly attaching the motor 104 (shown in FIG. 1) to the motor mount 106. This allows for a wide variety of motors 104 to be attached to the motor rod 122 (shown in FIG. 1) that is then attached to the articulating arm 118 via the second clamp 120. It is appreciated that while a clamp connection is illustrated herein, the motor 104 may be coupled to the articulating arm 118 with any other type of coupling connection as required or desired.

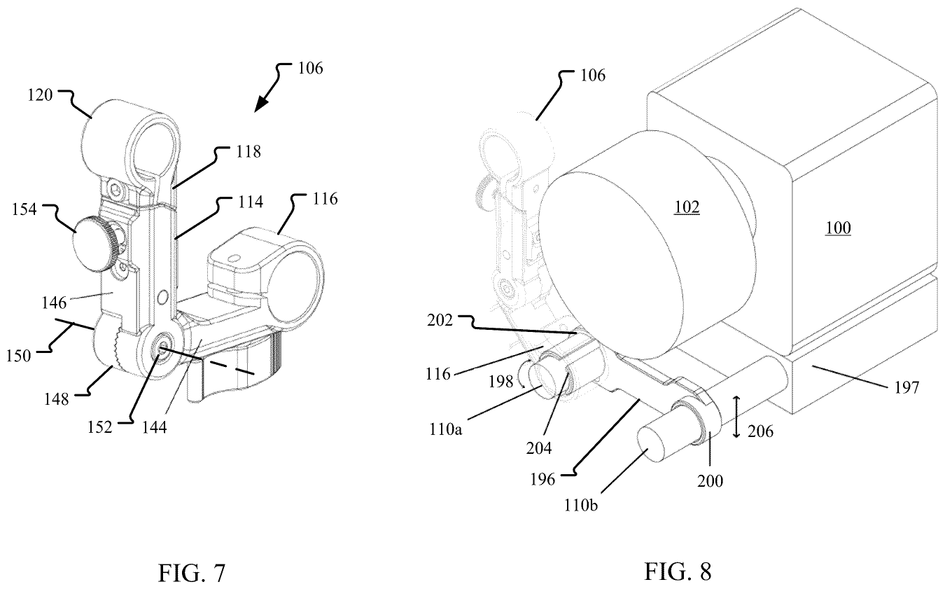

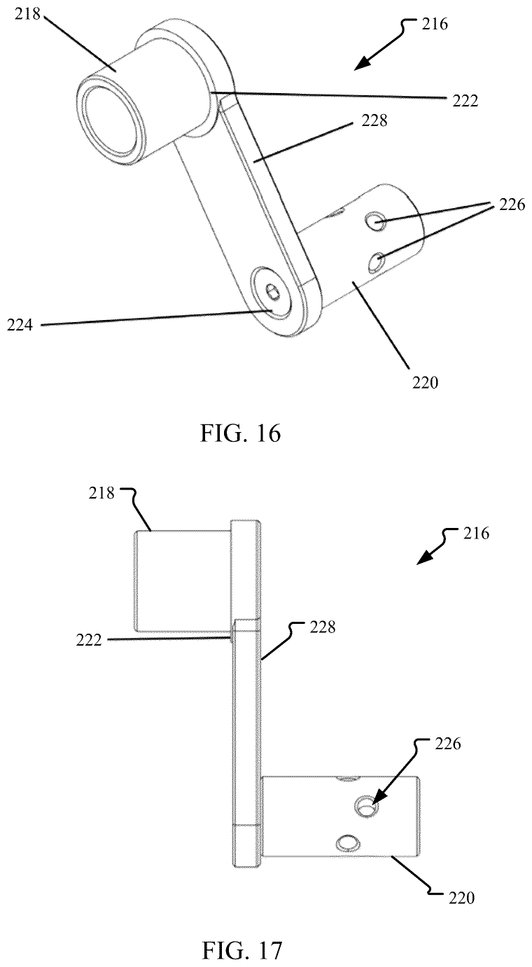

In the example, the main body 114 may be formed from two or more members 144, 146. The first member 144 forms the first end 128 of the main body 114 and includes the first clamp 116. The second member 146 forms the second end 130 of the main body 114 and includes the pivot point 138 for the articulating arm 118. The first and second members 144, 146 are rotatably coupled to one another at an adjustable angle joint 148. The adjustable angle joint 148 defines a rotational axis 150 that is parallel to and offset from the pivot axis 140. In the example, the adjustable angle joint 148 is formed by corresponding interlocking rosettes extending from each end of the first and second members 144, 146 and a fastener 152 (e.g., bolt) to secure the interlocking rosettes together at fixed angles. Accordingly, the first and second members 144, 146 are allowed to be selectively adjusted into different fixed angles around the rotational axis 150 and to facilitate positioning of the motor 104 attached to the articulating arm 118 that is positioned with the second member 146. Positioning of the motor 104 is more dynamic with the main body 114 formed by multiple members that articulate into fixed angular positions. FIG. 7 described below illustrates the first and second members 144, 146 positioned at a different rotational angle. Typically, the first and second members 144, 146 are adjusted during initial setup of the motor mount 106. In aspects, the main body 114 may be a single member as required or desired and as illustrated in FIG. 16 described below. In other examples, the adjustable angle joint 148 may be formed by any other structural joint configuration that enables operation of the main body 114 as described herein.

The actuator adjustment mechanism 124 is supported on the second member 146 of the main body 114 proximate the second end 130. The actuator adjustment mechanism 124 is coupled to the articulating arm 118 and is configured to drive the pivoting movement of the articulating arm 118 around the pivot axis 140 and relative to the main body 114. In the example, the actuator adjustment mechanism 124 includes a rotatable knob 154 disposed on an opposite side of the second member 146 from the articulating arm 118. Rotation of the knob 154 is configured to drive both pivoting movement of the articulating arm 118 away from the main body 114 and thereby positioning the attached motor 104 towards the lens 102 (shown in FIG. 1), and back towards the main body 114 and thereby positioning the attached motor 104 away from the lens 102.

In the example, the first member 144 of the main body 114 includes the first clamp 116 for attaching to the camera rod 110. The first clamp 116 may be configured to attach to one or more diameters of the camera rod 110. In other examples, the first member 144 may form different attachment modules for the motor mount 106. For example, a module for a 19 mm rod, or a module for a 15 mm rod, or a module that spans across multiple rods, such as two 15 mm rods with industry standard placement, two 19 mm rods with industry standard placement, or a 19 mm and a 15 mm rod with industry standard placement. This would eliminate the possibility of movement around a single rod and would reduce or eliminate the possibility that a single rod twists within its own fixture to the camera assembly.

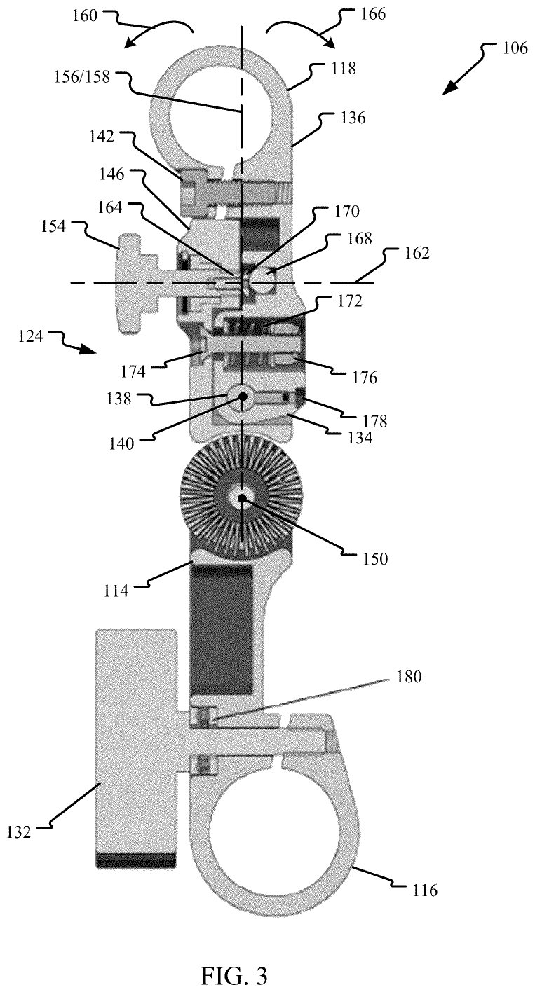

FIG. 3 is a cross-sectional view of the motor mount 106 in a first pivoted position. The first and second ends 134, 136 of the articulating arm 118 define an arm longitudinal axis 156 that extends through the pivot point 138. The second member 146 of the main body 114 also defines a body longitudinal axis 158 that extends through the pivot point 138. The body longitudinal axis 158 may also extend through the rotational axis 150 of the main body 114. In the first pivoted position, the arm and body longitudinal axes 156, 158 are co-axial and so that the articulating arm 118 is parallel to the second member 146 of the main body 114. In examples, this first pivoted position may be a position of the articulating arm 118 that positions the motor 104 away from the lens 102 (both shown in FIG. 1). In other examples, the first pivoted position may have the articulating arm 118 pivotably offset from the second member 146 and so that the arm and body longitudinal axes 156, 158 are not co-axial and not parallel to each other, but still in a position that the motor 104 is disengaged with the lens 102. In this first pivoted position, the second member 146 of the main body 114 restricts the articulating arm 118 from pivoting any further in a counterclockwise direction 160 relative to the pivot axis 140.

The actuator adjustment mechanism 124 includes the knob 154 that is mounted on the second member 146 of the main body 114 and rotatable around a rotation axis 162. The rotation axis 162 is orthogonal to the body longitudinal axis 158 and the pivot axis 140. Rotation of the knob 154 causes linear movement of a distal end 164 of the knob 154 along the rotation axis 162. The distal end 164 of the knob 154 is engaged with the articulating arm 118, and as such, extension of the distal end 164 from the main body 114 causes corresponding clockwise pivoting movement of the articulating arm 118 in a clockwise direction 166. Additionally, retraction of the distal end 164 into the main body 114 causes corresponding counterclockwise pivoting movement of the articulating arm 118 in the opposite counterclockwise direction 160. In the example, the distal end 164 of the knob 154 may engage with a ball bearing 168 carried by the articulating arm 118. In some examples, the distal end 164 of the knob 154 may include a set screw 170 for positioning adjustment and coupling the knob 154 to the main body 114. In aspects, the distal end 164 of the knob 154 may directly contact the ball bearing 168.

A biasing member 172 (e.g., a compression spring) is disposed within the articulating arm 118. The biasing member 172 is secured within the articulating arm 118 with a fastener 174 (e.g., bolt) and a nut 176, with the fastener 174 engaged with the second member 146 of the main body 114. In the example, the biasing member 172 provides a biasing force that acts in the counterclockwise direction 160 so as to urge the articulating arm 118 towards the main body 114 and the first pivoted position as illustrated in FIG. 3. The pivot point 138 may be a pin that is secured with a set screw 178.

The first clamp 116 includes a thrust bearing 180 for the tightening lever 132. The thrust bearing 180 is disposed between the tightening lever 132 and the threaded section of the first clamp 116. The thrust bearing 180 makes it much easier to achieve high clamping force than a clamping lever that contains no thrust bearing due to reduction of friction between the lever and the surface of the clamp. The second clamp 120 includes the fastener 142. In the example, the first and second clamps 116, 120 have openings that are parallel to each other. In other examples, the first and second clamps 116, 120 may be any other type of clamping system as required or desired.

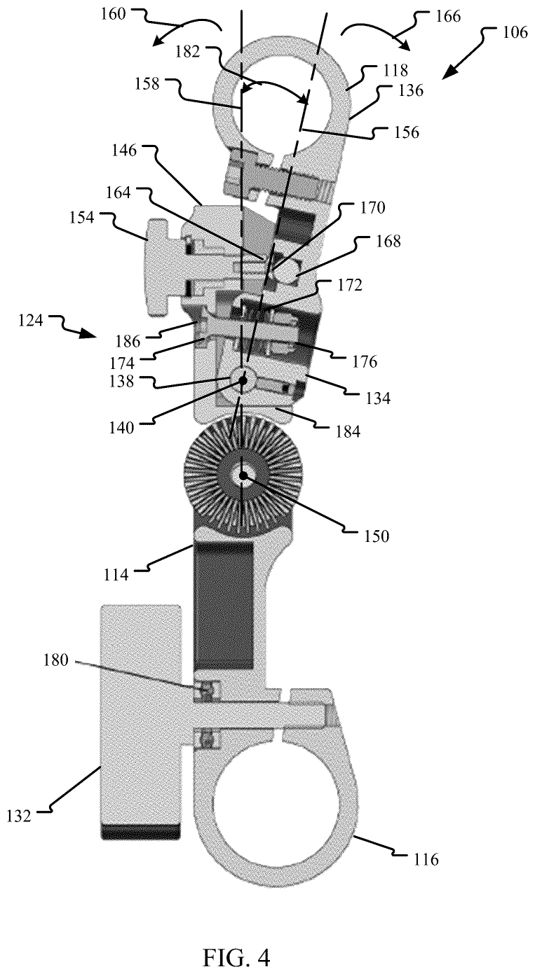

FIG. 4 is a cross-sectional view of the motor mount 106 in a second pivoted position.

Certain components are described above and are not necessarily described further in reference to FIG. 4. Upon rotation of the knob 154 so as to extend the distal end 164 towards the articulating arm 118, the articulating arm 118 is rotated in the clockwise direction 166 and in a direction away from the main body 114. This pivoting movement of the articulating arm 118 causes the arm longitudinal axis 156 to be positioned at an angle 182 relative to the body longitudinal axis 158 of the second member 146 of the main body 114. In the example, the angle 182 may be between 5° and 45°, between 5° and 35°, between 5° and 25°, between 10° and 20°, or between 10° and 15°. In an aspect, the angle 182 may be about 12° or any other angle as required or desired. The main body 114 defines a rotational stop surface 184 that is configured to engage with the first end 134 of the articulating arm 118 so as to define a maximum pivot angle of the articulating arm 118.

In operation, the motor mount 106 is configured so that the articulating arm 118 is restricted or prevented from being moved from the second pivoted position by outside forces, such as the force of the motor 104 (shown in FIG. 1) acting in the counterclockwise direction 160. The only way that the articulating arm 118 may rotate in the counterclockwise direction 160 is by turning the knob 154 and retracting the distal end 164 towards the main body 114. The knob 154 may be a bolt that is threaded into the main body 114. The biasing member 172, constrained by the fastener 174 and the nut 176 is applying a constant force in roughly the counterclockwise direction 160 by pulling the articulating arm 118 towards the main body 114.

The end of the knob 154 is in constant contact with the ball bearing 168 which provides a low friction contact point between the knob 154 and the articulating arm 118. The ball bearing 168 also provides a perpendicular surface of contact due to the variable angle of the articulating arm 118 during the pivoting movement. As the knob 154 linearly moves relative to the main body 114, the contact with the ball bearing 168 also moves allowing the entire articulating arm 118 to pivot. When the knob 154 extends the distal end 164, the knob 154 directly drives the pivoting movement of the articulating arm 118 in the clockwise direction 166. When the knob 154 retracts the distal end 164, the biasing member 172 urges the articulating arm 118 in the counterclockwise direction 160 and causes the pivoting movement of the articulating arm 118.

In the example, the fastener 174 and the nut 176 may at least partially move along with the articulating arm 118 via a chamfered hole 186 defined in the main body 114 and that allows the biasing member 172 to articulate while continuing to make contact with the main body 114. At any pivot position, the articulating arm 118 cannot move in the counterclockwise direction 160 any further than the point of contact between the distal end 164 of the knob 154 and the ball bearing 168. This is because the position of the knob 154 relative to the main body 114 via the threaded connection is stronger than the biasing force of the biasing member 172. However, when rotational force is applied to the knob 154 in the direction of the circumference of the knob 154 (e.g., screwing the knob 154 in or out of the main body 114), the knob 154 will turn easily and linearly move. The pivoting movement of the articulating arm 118 is constrained in the counterclockwise direction 160 by the main body 114 and in the clockwise direction 166 by the rotational stop surface 184 as well as by the maximum compression of the biasing member 172. The knob 154 is constrained from backing out of the main body 114 by the set screw 170 that cannot pass through a threaded section of the main body 114.

The knob 154 is configured to position the articulating arm 118 at any intermediate pivot position between the first pivoted position illustrated in FIG. 3 and the second pivoted position illustrated in FIG. 4, and by rotating the knob 154 either outward or inward relative to the articulating arm 118. Once attached to the articulating arm 118, the motor 104 (shown in FIG. 1) can subsequently be moved towards or away from the lens 102 (shown in FIG. 1) along with the movement of the articulating arm 118 and so that the motor 104 is engaged or disengaged with the lens 102. Accordingly, the actuator adjustment mechanism 124 facilitates easy engagement and disengagement of the motor 104 and without movement of the main body 114. Furthermore, the actuator adjustment mechanism 124 enables for the motor 104 to be over meshed or over engaged with the lens 102 with an increased engagement force. This positioning reduces or prevents torque induced by motor operation from undesirably disengaging the motor 104 from the lens 102 and as described herein.

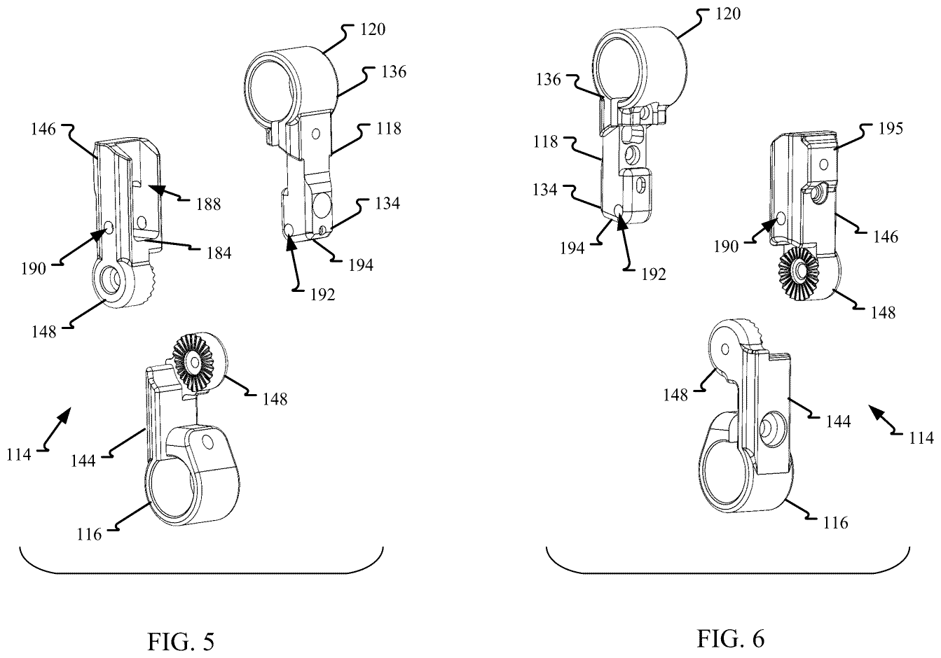

FIGS. 5 and 6 are exploded, perspective view of the main body 114 and the articulating arm 118 of the motor mount 106 (shown in FIG. 1). Referring concurrently to FIGS. 5 and 6, the main body 114 includes the first member 144 defining a portion of the first clamp 116 and a portion of the angle joint 148. The second member 146 of the main body 114 includes another portion of the angle joint 148 and also defines a U-shaped channel 188 elongated along the longitudinal axis. The U-shaped channel 188 is sized and shaped to receive the first end 134 of the articulating arm 118. The rotational stop surface 184 is defined within the U-shaped channel 188. In the example, a pivot pin extends through an opening 190 of the second member 146 and an opening 192 of the articulating arm 118 to define the pivot point 138 (shown in FIG. 2). The first end 134 of the articulating arm 118 includes an oblique surface 194 that is configured to engaged with the rotational stop surface 184. The second end 136 of the articulating arm 118 includes a portion of the second clamp 120. The second member 146 of the main body 114 may include a protruding boss 195 to support the knob 154 (shown in FIG. 2).

FIG. 7 is another perspective view of the motor mount 106. As illustrated in FIG. 7, the first member 144 and the second member 146 of the main body 114 are rotated relative to one another around the rotational axis 150 and via the adjustable angle joint 148. In this example, the first member 144 and the second member 146 are disposed substantially orthogonal to one another. In other aspects, the first member 144 may be disposed at an acute or obtuse angle relative to the second member 146. The adjustable angle joint 148 via the fastener 152 allows for the first member 144 and second member 146 to be positioned around the rotational axis 150 as required or desired and be secured in that position. Accordingly, the articulating arm 118 is more easily and quickly positioned relative to the lens 102 (shown in FIG. 1) for operation and positioning of the motor 104 (shown in FIG. 1) as described herein.

In the example, the articulating arm 118 of the motor mount 106 is intended to be quickly adjustable by use of the knob 154 and for positioning of the motor 104. Additionally, the main body 114 is made up of the first and second members 144, 146 that are also angularly adjustable. These two members 144, 146 of the main body 114 are configured to be fixed at an assortment of angles by using the adjustable angle joint 148. In the example, the adjustable angle joint 148 is a rosette joint that is intended to be configured during initial setup of the motor mount 106 and does not require the easy dynamic adjustment of the articulating arm 118. The rosette joint allows for a number of different angles that can be easily configured without worry that the adjustable angle joint 148 may slip during use. The adjustable angle joint 148 can be adjusted by loosening and tightening the fastener 152 (e.g., a bolt or thumb lever) and rotating the first and second members 144, 146 relative to one another. Any other type of secure adjustable joint could be used in place of the rosette, with any number of available angles.

The first member 144 of the main body 114 includes the first clamp 116 for attaching the motor mount 106 to the camera rod 110 (shown in FIG. 1). In the example, the first clamp 116 is configured to secure to different size camera rods as required or desired (e.g., a 15 mm rod and a 19 mm rod). In other examples, the first clamp 116 may be sized and shaped for a single size camera rod as required or desired. The second clamp 120 extends from the articulating arm 118 and is disposed outside of the second member 146 of the main body 114.

FIG. 8 is another perspective view of the camera 100 and the motor mount 106 with an anti-twist bracket 196. The camera 100 includes the lens 102 and a pair of camera rods 110a, 110b that extend from a camera mount 197 supporting the camera 100. During operation of the motor 104 (shown in FIG. 1), the motor 104 may generate a rotational torque force 198 that is transferred through the motor mount 106 and into the camera rod 110. This torque force 198 may cause rotation of the camera rod 110 relative to the camera mount 197 and corresponding undesirable movement of the motor mount 106 and the motor 104.

A separate accessory, the anti-twist bracket 196, that spans between two camera rods 110a, 110b may be used in conjunction with the motor mount 106 to restrict or prevent this twisting of the camera rod 110. In the example, the anti-twist bracket 196 is a rigid accessory that spans between two camera rods 110a, 110b (which usually have an industry-standard spacing between the rods). A first side 200 of the anti-twist bracket 196 has a hole with a fixed interior diameter so that it can easily slide onto the camera rod 110b but with very little play. The opposite second side 202 of the anti-twist bracket 196 is similar, but with an extended tube 204 that also has a similar interior diameter so as to slide onto the camera rod 110a. An outer diameter of the tube 204 is configured for the motor mount 106 to secure over and with the first clamp 116.

With the tube 204 fixed to the camera rod 110a due to the force of the first clamp 116 of the motor mount 106, and the first side 200 of the anti-twist bracket 196 placed over the other camera rod 110b, the first side 200 of the anti-twist bracket 196 in conjunction with the contained camera rod 110b restricts movement in an angular upwards or downwards direction 206, disallowing the other camera rod 110a, which is effectively fixed to the tube 204 due to the clamping force generated by the first clamp 116 of the motor mount 106, from twisting in the rotational direction of the torque force 198. This means that the motor 104 connected to the lens 102 via the motor mount 106 cannot move away from the lens 102 by means of a twisting camera rod 110a. In aspects, the anti-twist bracket 196 can be used without the motor mount 106 and have its own separate clamp at the tube 204 of the anti-twist bracket 196. In other examples, some FIZ motors may have integrated rod clamps that can fit directly over the tube 204 yielding the same result in place of the first clamp 116. Additionally, the anti-twist bracket 196 may be sized and shaped for either 15 mm camera rods or 19 mm camera rods as required or desired.

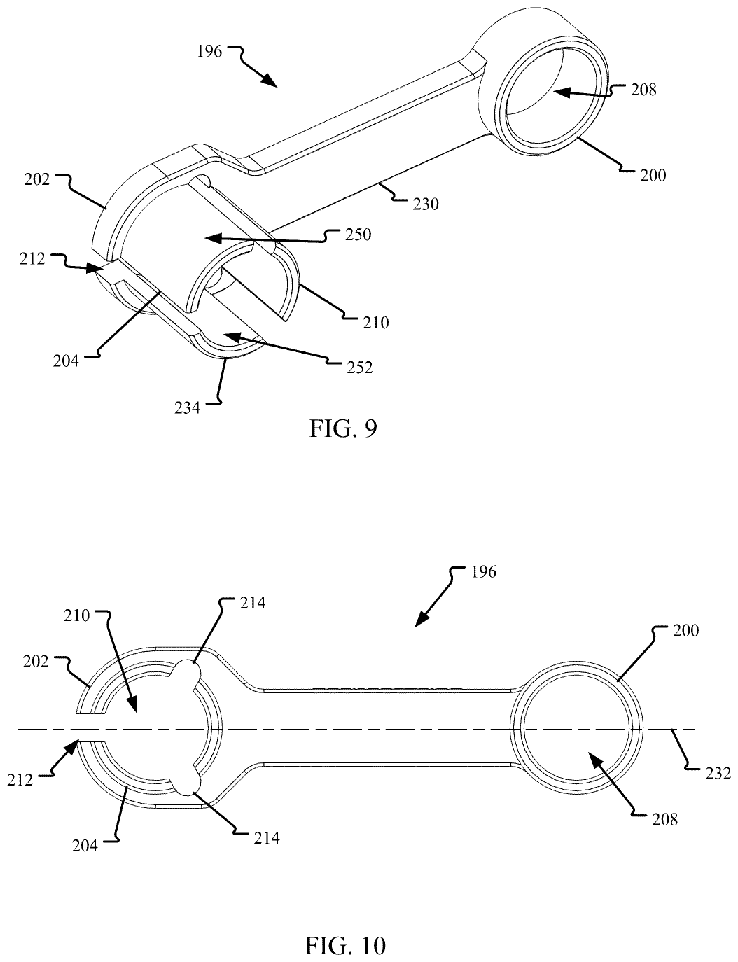

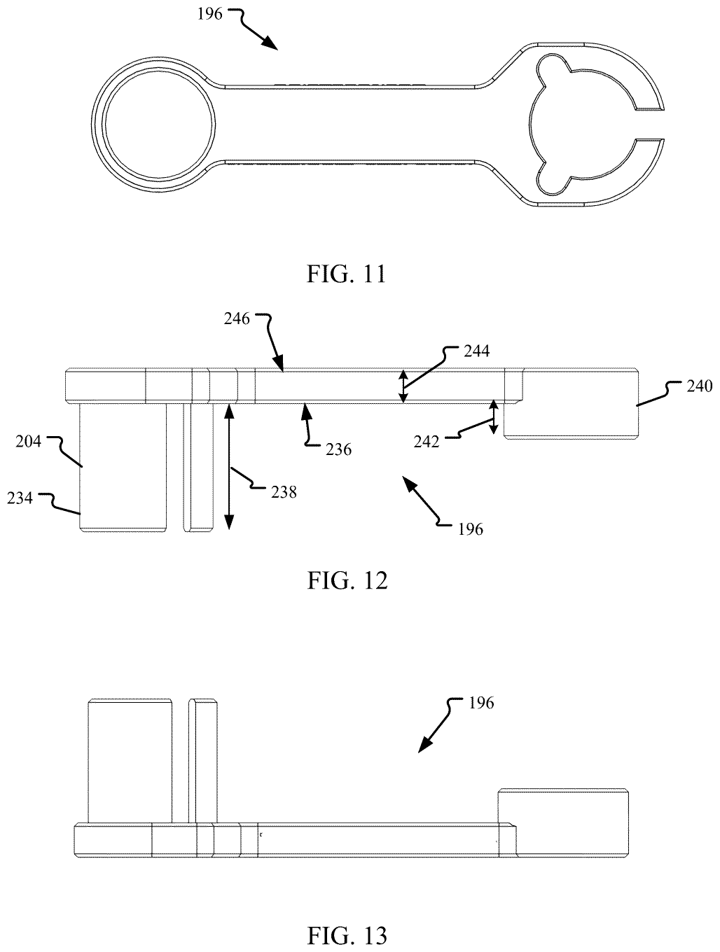

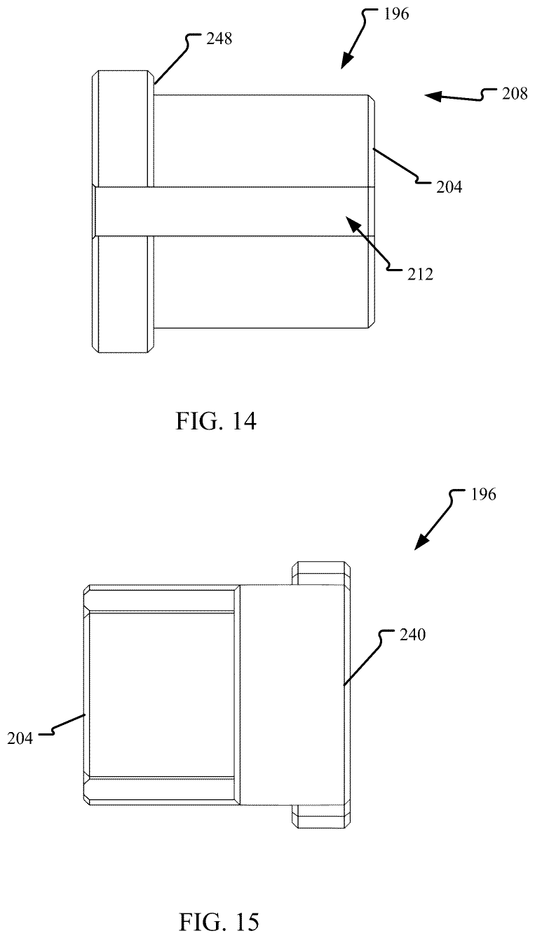

FIG. 9 is a perspective view of the anti-twist bracket 196. FIGS. 10-15 are front, rear, top, bottom, left-side, and right-side views of the anti-twist bracket 196. Referring concurrently to FIGS. 9-15, the anti-twist bracket 196 is formed from a body 230 having a first end or side 200 and an opposite second end or side 202 defining a longitudinal axis 232. The first side 200 includes a first hole 208 sized and shaped to receive the camera rod 110b (shown in FIG. 8). The opposite second side 202 also includes a second hole 210 sized and shaped to receive the camera rod 110a (shown in FIG. 8). In the example, the first hole 208 has a first diameter that is equal to a second diameter of the second hole 210. The first and second holes 208, 210 are defined in a direction that is orthogonal and transverse to the longitudinal axis 232. In other examples, the first hole 208 and the second hole 210 may have different diameters. The second hole 210 is formed at least partially by the tube 204 extending there around. A gap 212 in the tube 204 and the body 230 allows for the tube 204 to compress to a smaller diameter around the camera rod 110a, and with additional flexibility allowed by slits 214 defined in the body 230. As such, the tube 204 is defined by a plurality of circumferentially spaced arms 234. This allows for a circular clamp, such as the one on the motor mount 106 (shown in FIG. 7) to be placed over the tube 204, and when clamped down, compresses the tube 204 so that the inner diameter shrinks and can therefore tighten and clamp in a fixed position to the camera rod 110a.

The body 230 has a front side 236 that the tube 204 projects from. The tube 204 has a projection distance 238 from the front side 236 and each arm 234 has the same projection distance 238. In other examples, each arm 234 may have different projection distances as required or desired. The first side 200 has a collar 240 that surrounds the first hole 208 and the collar 240 projects from the front side 236 of the body 230 with a projection distance 242. The projection distance 238 of the tube 204 is greater than the projection distance 242 of the collar 240. This configuration increases space along the camera rod on the side that the motor mount does not couple to. In an aspect, the projection distance 238 of the tube 204 is at least double, at least triple, or at least quadruple the projection distance 242 of the collar 240. In the example, the projection distance 242 of the collar 240 may be substantially equal to a thickness 244 of the body 230. A rear side 246 of the body 230 is planar and does not include any projections therefrom.

In the example, there are three arms 234 that define the tube 204 and are circumferentially spaced around the second hole 210. The gap 212 is defined through the arms 234 and the second side 202 of the body 230. The gap 212 is in communication with the second hole 210. The slits 214 are defined in the body 230 and facilitate flexure of the second side 202 of the body 230 and for clamping of the motor mount. There may be two slits 214 disposed above and below the longitudinal axis 232. As such, the slits 214 and the gap 212 are spaced about 120° around the second hole 210. In other examples, only one slit 214 may be used. In still other examples, the gap 212 may be formed as a slit 214. In yet other examples, the gap 212 may be formed at the bottom or top side of the body 230 as required ore desired. The slits 214 are also in communication with the second hole 210. The second side 202 of the body 230 is enlarged relative to the collar 240 such that a flange 248 is formed for structural support of the arms 234 while still facilitating compression of the tube 204.

The arms 234 define an outer surface 250 of the tube 204 and configured to receive the motor mount clamp therearound. An inner surface 252 of the tube 204 is configured to face and couple against the camera rod. A middle portion of the body 230 between the first and second ends 200, 202 is substantially rigid and rectangular in cross-sectional shape such that the body 230 acts as a structural support between the camera rods and to restrict or prevent rotation of the camera rods attached thereto.

In some examples, the anti-twist bracket 196 may also be constructed with an additional support clamp (not shown) on either side 200, 202 for additional support. In other examples, a hinge (not shown) could be added at the edge of the side 200 (at the furthest point from the gap 212) and the body of the bracket has two portions connected at the hinge thereby allowing the entire bracket to swing open, be inserted onto the camera rods from the side, then clamped onto and fix the anti-twist bracket and its hinge in place. This would be useful in the case where another motor or accessory is mounted in front of the desired anti-twist bracket placement, and the bracket cannot be slid into place directly from the distal ends of the camera rods. In still another example, the side 200 could mirror the other side 202 by including a second tube and corresponding gaps and/or slits, allowing a motor mount or motor to be mounted to either or both ends of the bracket 196.

FIG. 16 is a perspective view of an offset arm 216 for use with the motor mount 106 (shown in FIG. 1). FIG. 17 is a side view of the offset arm 216. Referring concurrently to FIGS. 16 and 17, in some use based instances, when the motor mount 106 is mounted on the camera rod 110, the second clamp 120 (the motor 104 mounting location) can be spaced fairly far apart from the location of the motor gear 112 on the motor 104 (all shown in FIG. 1). Depending on the motor type, the distance from the motor gear 112 to the second clamp 120 can become even greater, and, in some instances, almost unusable due to the engagement point of the motor gear 112 to the lens gear 108 being too far away from the second clamp 120. To solve this problem, the offset arm 216 can be added between the motor mount 106 and the motor 104 so as to move the position of the motor gear 112 relative to the motor mount 106.

The offset arm 216 has a fixed rod 218 or an interchangeable rod 220 on each end. At the end that attaches to the motor mount 106, there is an added spacer 222 which moves the offset arm 216 just far enough from the motor mount 106 to allow the articulating arm 118 (shown in FIG. 1) to articulate without allowing any section of the motor mount 106 to rub against the offset arm 216. Interchangeable rod 220 can be interchanged between 19 mm and 15 mm diameters by use of a fastener 224 (e.g., a bolt). Threaded holes 226 may be defined within the interchangeable rod 220 and positioned so that certain types of standard motors 104 may be attached. The end of the offset arm 216 with the fixed rod 218 would then be attached to the motor mount 106. Interchangeable rod 220 cannot twist after being attached due to an interlocking key (not shown) between the interchangeable rod 220 and a main arm 228.

In operation, the motor 104 is attached via its own rod clamp (or by way of fasteners using the threaded holes) to the interchangeable rod 220 and at one end of the offset arm 216. At the other end of the offset arm 216 is the fixed rod 218 that is clamped by the second clamp 120 of the articulating arm 118 of the motor mount 106. The motor mount 106 itself is fixed to the camera rod via the first clamp 116. This configuration allows the motor 104 to be placed with the motor gear 112 as close to the second clamp 120 of the motor mount 106 as possible and keeping the entire setup compact.

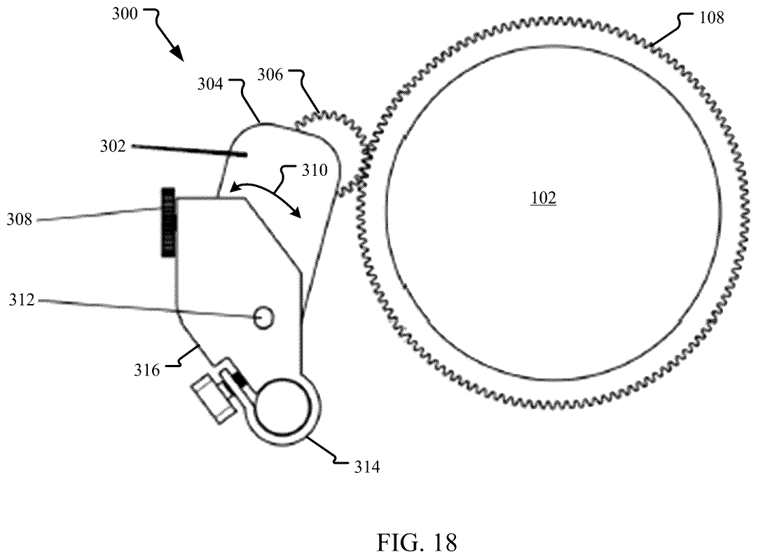

FIG. 18 is a side view of another motor mount 300 and in an engaged position with the lens 102. In this example, the motor mount 300 includes a motor 302 that is integrated into an articulating arm 304. For instance, the motor 302 and a motor gear 306 can be directly and permanently attached to the articulating arm 304 of the motor mount 300. This could be a useful integration as it would eliminate the need for a separate motor clamp, as well as allow for the motor 302 and the motor gear 306 to be integrated directly in line with a camera rod clamp 314, rather than as an offset attachment. Such integration of the motor 302 directly into the articulating arm 304 would also reduce the overall footprint of the motor mount 300 on the camera rod, making it easier to mount motors close together and/or next to each other. Another benefit would be that the forces generated by the motor gear 306 and the motor 302 would be directly in line with the articulating arm 304. In examples, the motor 302 may be supported in a housing that is disposed on the free end of the articulating arm 304 and instead of a motor clamp. Direct integration of the motor 302 could be especially useful for smaller wireless lens control motors intended for use with lightweight cameras and compact setups. This example depicts a configuration similar to one where if on the motor mount, the articulating arm is permanently fixed to a motor and gear, rather than having a second clamp.

As illustrated in FIG. 18, the motor mount 300 is in its engaged position and the motor gear 306 is engaged with the lens gear 108 and so as to drive operation thereof. Similar to the embodiment described above turning an actuator 308 (e.g., knob) will move the articulating arm 304 housing the motor 302 towards or away from the lens 102 in an angular direction 310 around a pivot point 312. The entire motor mount 300 is mounted in a fixed position to the camera rod via the camera rod clamp 314 so that only the articulating arm 304 needs to be adjusted using the actuator 308 to engage or disengage from the lens 102. In this example, a main body 316 may be a single element component and without an adjustable angle joint. In other examples, the main body 316 may include the adjustable angle joint and formed from two or more members as required or desired.

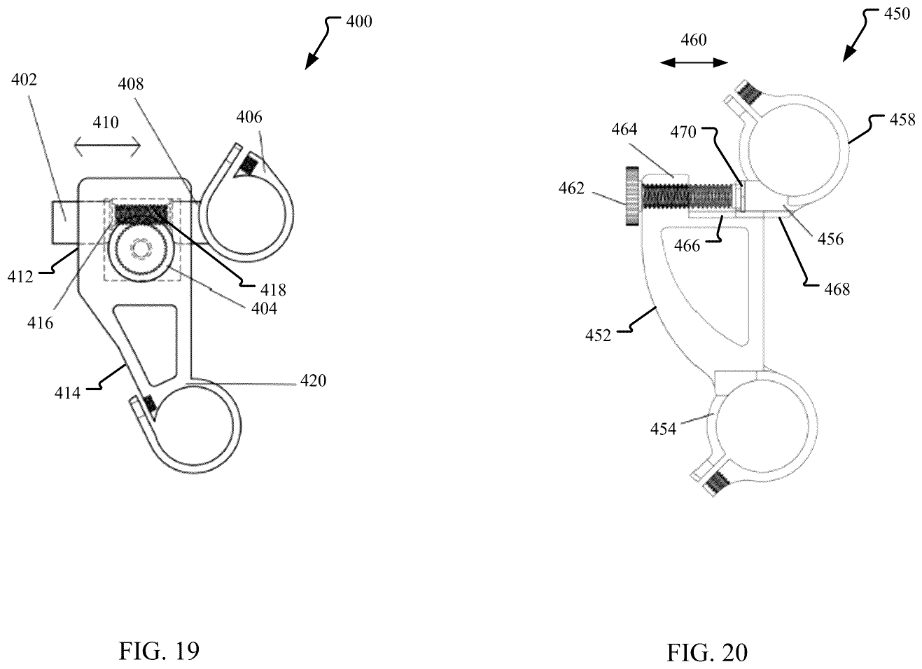

FIG. 19 is a side view of another motor mount 400. Other configurations of the motor mount described herein and that rely on mechanisms other than the pivoting articulating arms described above can also be possible. For instance, instead of the articulating arm moving pivotably around a pivot axis, the arm can be configured to linearly slide to and away from the lens and between engaged and disengaged positions. In an example, the motor mount 400 includes a linearly sliding arm 402 that is positioned by use of an actuator 404 (e.g., a rotatable knob). In this example, the arm 402 includes a motor clamp 406 at one end and configured to couple to a motor. In other examples, the arm 402 may house an integrated motor as required or desired. Extending from the motor clamp 406, the arm 402 includes an elongated driving member 408 that is constrained to movement only in a linear direction 410 by a guide channel 412 formed on a main body 414 and limited in the linear directions 410 by stoppers 416 on each end of a worm gear 418. The elongated driving member 408 may be rectangular in shape and is split into two sections that are connected to each end of the worm gear 418, which is moved in the linear direction 410 by the turning of the actuator 404 having an interlocking gear. In the example, rotation of the actuator 404 is along a rotational axis that is orthogonal to the linear direction 410 of movement of the arm 402. The main body 414 is configured to be fixed to the camera rod using a camera rod clamp 420. In the example, the main body 414 is formed from a single component. In other examples, the main body 414 may include two or more members pivotably coupled together as required or desired.

In operation, the actuator 404 is configured to move the motor clamp 406 of the arm 402 in the linear direction 410 between at least a first position, whereby the motor is retracted relative to the main body 414 and in a disengaged position relative to a lens, and a second position, whereby the motor is extended relative to the main body 414 and in an engaged position relative to a lens and without movement of the main body 414 on the camera rod.

FIG. 20 is a side view of another motor mount 450. In this example, the motor mount 450 has a main body 452 that is configured to be fixed to a camera rod by a camera rod clamp 454. An arm 456 includes a motor clamp 458 and is configured to linear slide 460 on the main body 452 and to engage and disengage an attached motor as an actuator 462 (e.g., a knob) is rotated in or out of the main body 452. The actuator 462 is attached to the arm 456 such that it is constrained in the direction of the linear movement, but not in the direction of the knob rotation. This allows for the knob to rotate and linearly move in between an engaged position and a disengaged position for the motor and as directed by the thread in a main block 464 of the main body 452 while being turned. In the example, the rotation of the actuator is along a rotational axis that is orthogonal to the linear movement direction.

The actuator 462 is configured to push or pull the arm 456 along a channel 466 defined in the main body 452, and the arm 456 is guided through the channel 466 by a corresponding dovetail 468. The actuator 462 is constrained within the arm 456 in the forward/backward position by a lip 470 while still being allowed to rotate. In other examples, the arm 456 may contain threads, and the knob could be constrained in the forward/backward linear position, still being able to rotate, and therefore acting on the arm to engage and disengage along the sliding channel. In the example, the main body 452 is formed from a single component. In other examples, the main body 452 may include two or more members pivotably coupled together as required or desired. Additionally, or alternatively, the motor may be integrated within the arm 456 as required or desired.

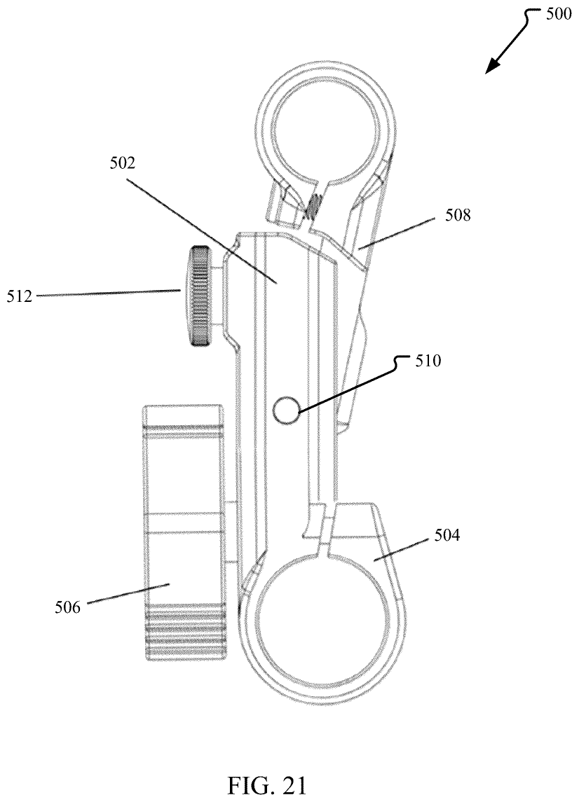

FIG. 21 is a side view of another motor mount 500. The motor mount 500 is similar to the motor mount 106 described above, however, a main body 502 is formed as a single component and includes a first end having a camera rod clamp 504 with a lever 506 and an opposite second end that an articulating arm 508 extends from. The articulating arm 508 is selectively pivotable around a pivot point 510 and via an actuator 512, and as described in detail above.

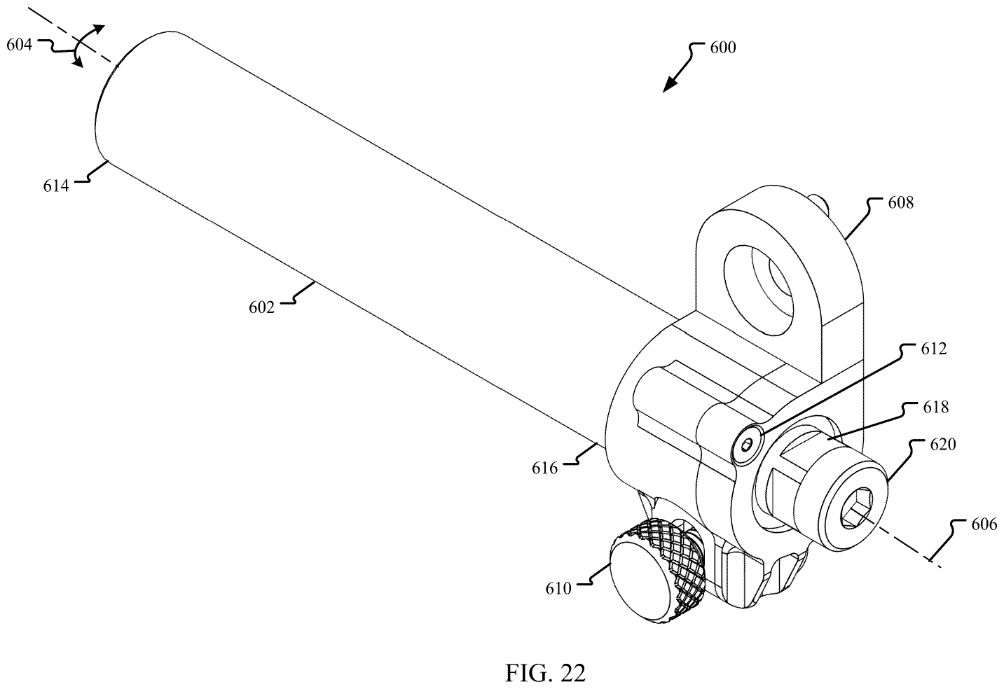

FIG. 22 is a perspective view of a rotatable camera rod assembly 600. In the examples described above, a motor mount is used to support a motor for engagement with a camera lens and the motor mount is supported on a fixed camera rod. In the example described below, a camera rod 602 is provided for supporting a motor (not shown) or any other component as required or desired. However, the camera rod 602 is configured to pivot 604 around a longitudinal axis 606 so that when a motor is attached to the camera rod 602, the motor, via the pivoting camera rod 602, can pivot relative to the camera lens and the motor can move towards and away from the camera lens. Accordingly, all of the technical benefits of the selective movement of the motor described above are provided via a pivoting movement of the camera rod 602.

In the example, the rotatable camera rod assembly 600 includes a camera mount 608 that is configured to couple to a camera. In an aspect, the camera mount 608 is configured to attach to a side of a camera so that the camera rod 602 is positioned on a side of the camera lens. In other aspects, the camera mount 608 may attach to a top or a bottom of the camera as required or desired. An actuator 610 (e.g., a rotatable thumbturn) is mounted on the camera mount 608. Rotation of the actuator 610 is configured to drive the pivoting movement of the camera rod 602 around the longitudinal axis 606. In the example, the camera mount 608 may be a two-piece housing that is coupled together with a fastener 612 (e.g., bolt). The camera rod 602 includes a distal end 614 and a proximal end 616 extending along the longitudinal axis 606. The proximal end 616 is pivotably coupled to the camera mount 608 via a rotor 618 and a bolt 620.

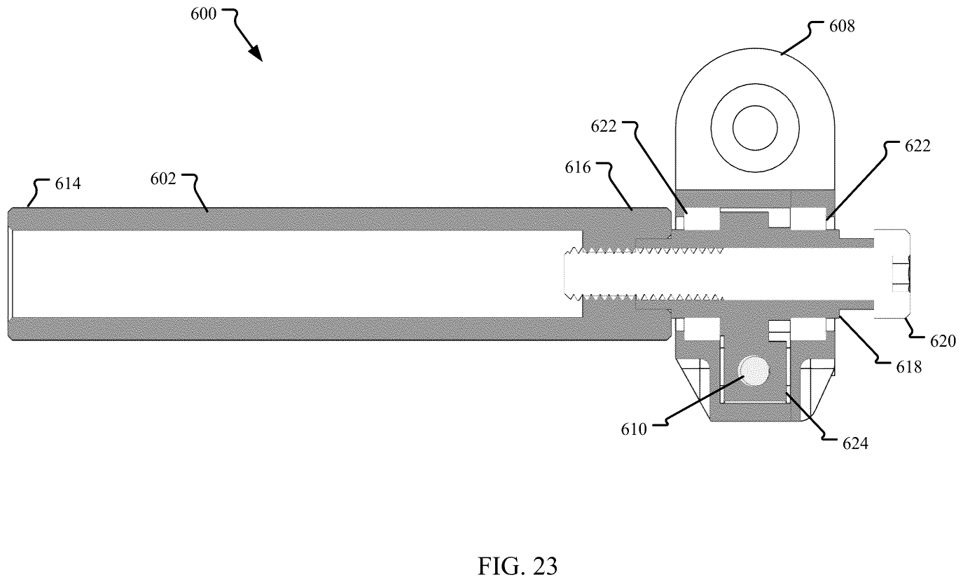

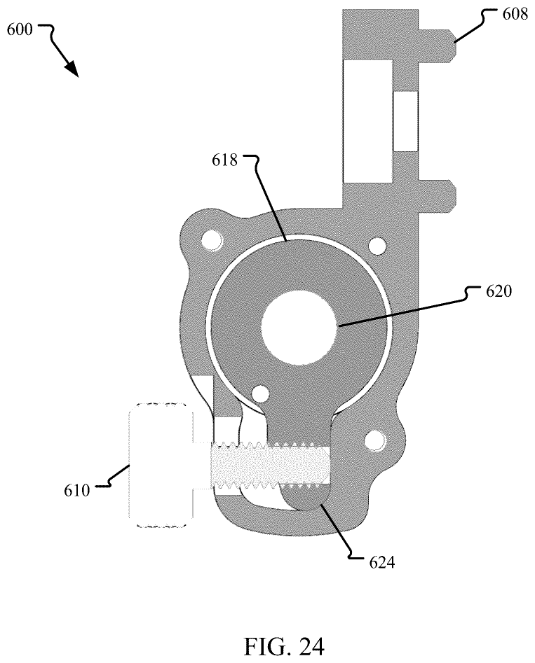

FIGS. 23 and 24 are cross-sectional views of the rotatable camera rod assembly 600. Referring concurrently to FIS. 23 and 24, the bolt 620 couples to the proximal end 616 of the camera rod 602 via a threaded connection. The rotor 618 is captured between the bolt 620 and the camera rod 602 and pivotably supported within the camera mount 608 by a pair of bearings 622. The rotor 618 includes a radially extending flange 624 that is engaged with the actuator 610. In the example, the actuator 610 is threadably engaged with the flange 624 such that rotation of the actuator 610 drives corresponding rotation of the rotor 618, and thereby, pivoting of the camera rod 602. The camera mount 608 defines the pivoting stop limits for the rotor 618. In operation, a motor (not shown) is coupled to the camera rod 602 and the position of the motor relative to the corresponding camera lens is controlled by the pivoting movement of the camera rod 602 via the actuator 610.

In some examples, the camera rod 602 may be coupled to the camera mount 608 by a clamp and thumb lever (not shown) so as to allow the camera rod 602 to be easily removable for changing camera rods 602 (e.g., changing camera rod lengths and/or diameters). In other examples, the rotor 618 and camera rod 602 may be rotated completely around the longitudinal axis 606 by the actuator 610 rather than having defined stopping points via the camera mount 608. Different iterations of this configuration may readily present themselves while still having a camera rod (removable or fixed) that pivots or rotates around the longitudinal axis 606 controlled by an actuator 610, all of which are attached to any form of the camera mount 608 and that comprises the entire assembly 600.

Aspects of any of the above versions and configurations of the described motor mount can easily be interchanged or integrated with each other and/or directly with FIZ motors. A number of similar configurations which achieve the purpose of, through only the turning of a single knob or lever, engaging a lens motor and applying optional pre-load while remaining fixed to the camera rod or camera body may readily present themselves.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A motor mount for a cinematography lens of a camera comprising:
a main body having a first end and an opposite second end, the first end configured to fixedly couple to a camera rod of the camera;
an arm movably supported on the main body, the arm including a clamp configured to couple to a motor; and
an actuator supported on the main body proximate the second end, the actuator coupled to the arm such that the clamp of the arm is moveable via the actuator between at least a first position whereby the motor is disengaged with the cinematography lens and a second position whereby the motor is engaged with the cinematography lens without movement of the main body on the camera rod.

2. The motor mount of claim 1, wherein the arm is pivotably coupled to the main body and the clamp of the arm is pivotable between the first and second positions.

3. The motor mount of claim 2, wherein the actuator includes a biasing member that biases the arm and the clamp towards the first position.

4. The motor mount of claim 2, wherein the second end of the main body defines elongated channel and the arm is at least partially disposed within the elongated channel, and wherein an end wall of the elongated channel defines a rotational stop for the arm.

5. The motor mount of claim 2, wherein the arm is pivotable relative to the main body around a pivot axis, and wherein the actuator is a knob rotatable around a rotation axis, the pivot axis orthogonal relative to the rotation axis.

6. The motor mount of claim 1, wherein the main body includes two or more members with an adjustable angle joint therebetween.

7. The motor mount of claim 6, wherein a first member of the two or more members has a second clamp that couples to the camera rod of the camera and a second member of the two or more members supports the arm such that the arm is spaced apart from the first member.

8. The motor mount of claim 7, wherein the clamp of the arm is disposed outside of the second member.

9. The motor mount of claim 1, wherein the first end of the main body includes a clamp having a thrust bearing for attaching to the camera rod.

10. The motor mount of claim 1, wherein the arm further includes the motor housed at least partially within the arm.

11. The motor mount of claim 1, further comprising an anti-twist bracket having a first end coupled to the first end of the main body and an opposite second end configured to couple to a second camera rod of the camera.

12. A motor mount for a cinematography lens of a camera comprising:
a main body having a first end and an opposite second end, the first end configured to fixedly couple to a camera rod of the camera;
an articulating arm having a first end and an opposite second end, the first end pivotably coupled to the main body at a pivot axis, the pivot axis disposed between the first and second ends of the main body, the second end configured to support a motor; and
an actuator supported on the main body proximate the second end of the main body, the actuator coupled to the articulating arm such that the actuator drives pivoting movement of the articulating arm around the pivot axis relative to the main body.

13. The motor mount of claim 12, wherein the main body includes a first member at the first end of the main body and a second member at the second end of the main body, the first member including a clamp for securing the main body to the camera rod, and wherein the first member and the second member are coupled at a joint such that an angle between the first member and the second member is adjustable.

14. The motor mount of claim 13, wherein the joint between the first member and the second member is a rosette joint.

15. The motor mount of claim 12, wherein the actuator includes a threaded knob having a distal end engaged with the articulating arm and a biasing member configured to urge the articulating arm towards the main body.

16. The motor mount of claim 12, wherein the second end of the articulating arm includes a clamp configured to couple to the motor.

17. The motor mount of claim 12, wherein the articulating arm further includes the motor housed at least partially within the second end of the articulating arm.

18. The motor mount of claim 12, further comprising an offset arm having a first end attached to the second end of the articulating arm and an opposite second end configured to support the motor.

19. The motor mount of claim 12, further comprising an anti-twist bracket having a first end coupled to the first end of the main body and an opposite second end configured to couple to a second camera rod of the camera.

20. An anti-twist bracket for a camera comprising:
a body having a first end and an opposite second end defining a longitudinal axis;
a collar defining a first hole disposed at the first end of the body;
a tube defining a second hole disposed at the second end of the body, the tube and the collar extending from the same side of the body, wherein the tube is defined by a plurality of circumferentially spaced arms defining an outer surface for receiving a motor mount, wherein the second end of the body defines a gap in communication with the second hole and configured to enable compression of the tube, and wherein at least one slit is defined within the body between two of the plurality of circumferentially spaced arms and in communication with the second hole.
